(19) United States
(12) Patent Application Publication
(10) Pub. No.: US 2015/0069143 A1
(43) Pub. Date: Mar. 12, 2015

(54) ULTRASONIC SPRAY SYSTEM

(71) Applicant: Yu-Chi Yen, Changhua County (TW)

(72) Inventor: Yu-Chi Yen, Changhua County (TW)

(21) Appl. No.: 14/024,615

(22) Filed: Sep. 11, 2013

(51) Int. Cl. B05B 17/00

(52) U.S. Cl. CPC B05B 17/0646
USPC 239/102.2

(57) ABSTRACT

An ultrasonic spray system includes an atomizer, a main reservoir and an auxiliary reservoir. The atomizer includes a seat body and an ultrasonic vibration plate mounted in the seat body. The seat body defines a chamber and an opening in communication with the chamber. The ultrasonic vibration plate is disposed in between the chamber and the opening of the seat body and configured to transform liquid stored in the chamber into fine droplets. The main reservoir is arranged in fluid communication with the chamber of the seat body for supplying liquid to the atomizer. The auxiliary reservoir is arranged in fluid communication with the main reservoir. In particular, the main reservoir is fanned with a near-vacuum above liquid therein such that while some of the liquid flows from the main reservoir to the chamber of the atomizer, make-up liquid is automatically added to the main reservoir from the auxiliary reservoir.

### BACKGROUND OF THE INVENTION

1. Field of the Invention The present invention relates to an ultrasonic spray system and more particularly to an ultrasonic spray system that holds a large volume of liquid to be atomized such that the system can operate for a long period of time without refilling.

2. Description of the Related Art

U.S. Pat. No. 7,669,782 discloses a conventional atomizing device 9 which, as reproduced in FIG. 7, includes a body 90 and an atomizer 91 received in a recess 901 defined in a side of the body 90. The atomizer 91 includes a vibrating element 911, a lid 912 and a spray plate 913 secured in between the vibrating element 911 and the lid 912. In use, liquid is first introduced into a cavity 902 of the body 90 via an inlet 904 defined in a top of the body 90. The liquid then flows through a hole 903 in the body 90 and a central bore 914 in the vibrating element 911 and finally to the spray plate 913. The spray plate 913 vibrates with the vibrational energy generated by the vibrating element 911 and therefore transforms the liquid into a cloud of fine droplets that exits the atomizer through tiny apertures 915 of the spray plate 913.

However, the body 90 of the atomizing device 9 only has small liquid capacity and should be refilled at short intervals to avoid drying out. If the cavity 902 in the body 90 is empty, noise will be produced and the lifespan of the atomizer 91 may therefore be shorten. To solve this problem, one may try to increase the volume of the cavity 902 of the body 90; however, this may increase the water pressure through the spray plate 913, causing the liquid to escape fast through the apertures 915 of the spray plate 913 before being atomized.

### SUMMARY OF THE INVENTION

Accordingly, it is an object of the present invention to provide an ultrasonic spray system that can hold a large volume of liquid to be atomized such that the system can operate for a long period of time without refilling.

To achieve the foregoing objective, the ultrasonic spray system includes an atomizer, a main reservoir and an auxiliary reservoir. The atomizer includes a seat body and an ultrasonic vibration plate mounted in the seat body. The seat body defines a chamber and an opening in communication with the chamber. The ultrasonic vibration plate is disposed in between the chamber and the opening of the seat body and is configured to transform liquid stored in the chamber into fine droplets that exit the atomizer through the opening in the form of a fog. The main reservoir is arranged in fluid communication with the chamber of the seat body of the atomizer for supplying liquid to the atomizer. The auxiliary reservoir is arranged in fluid communication with the main reservoir. In particular, the main reservoir is formed with a near-vacuum above liquid therein such that while some of the liquid flows from the main reservoir to the chamber of the atomizer, make-up liquid is automatically added to the main reservoir from the auxiliary reservoir.

Preferably, the ultrasonic vibration plate defines a plurality of apertures therein and is placed upright in the seat body of the atomizer such that the resulting fine droplets are able to be discharged through the apertures of the ultrasonic vibration plate horizontally.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an ultrasonic spray system in accordance with the preferred embodiment of the present invention;

FIG. 2 is a cross-sectional view of the ultrasonic spray system shown in FIG. 1, taken along line II-II;

FIG. 3 is an enlarged perspective view of an atomizer of the ultrasonic spray system shown in FIG. 1;

FIG. 4 is another perspective view of the atomizer shown in FIG. 3, partially broken to show the interior thereof;

FIG. 5 is yet another perspective view of the atomizer shown in FIG. 3, partially broken to show the interior thereof;

FIG. 6 is a cross-sectional view of the atomizer shown in FIG. 3, taken along line VI-VI;

FIG. 7 is a prior art.

### DETAILED DESCRIPTION OF EMBODIMENTS

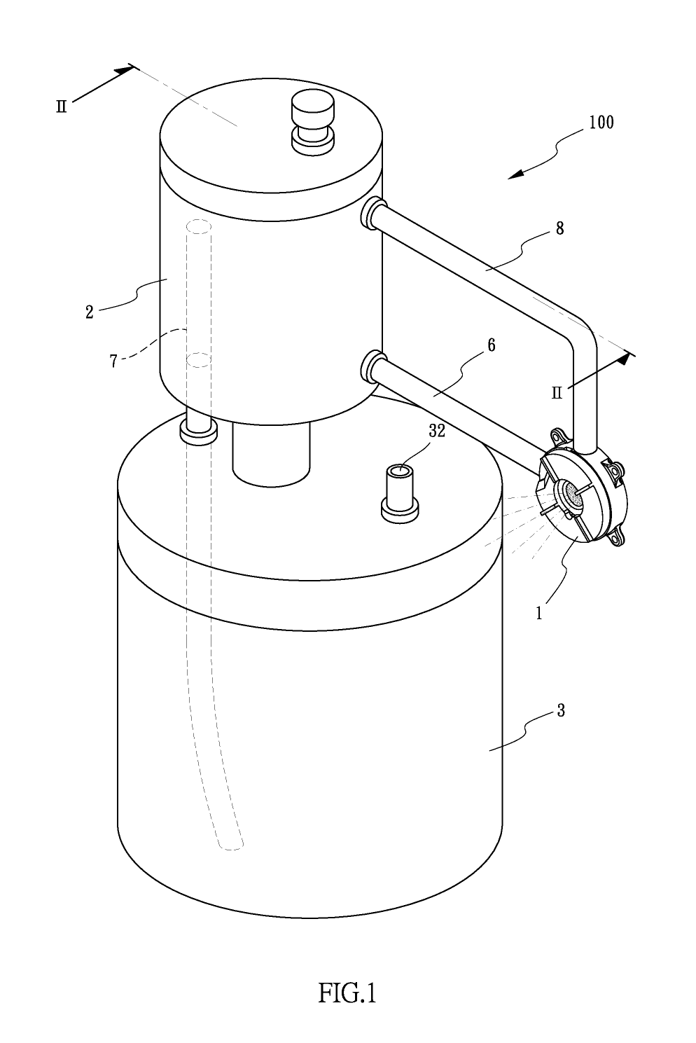

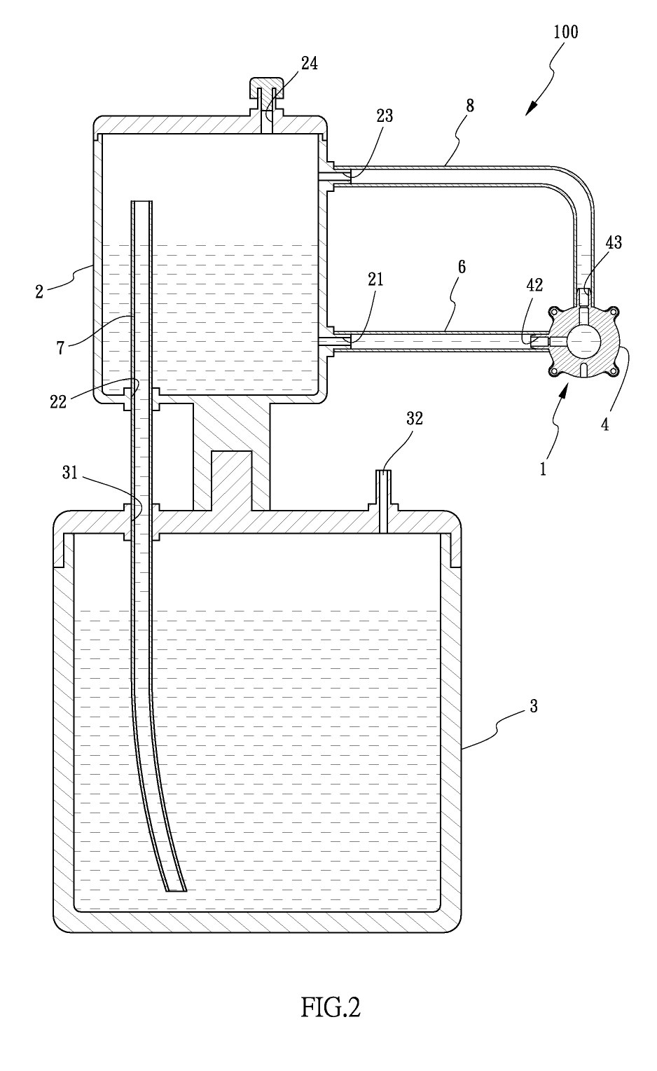

Referring to FIG. 1 or 2, there is shown the preferred embodiment of an ultrasonic spray system 100 of the present invention. The ultrasonic spray system 100 generally includes an atomizer 1, a main reservoir 2 for supplying liquid to the atomizer 1, and an auxiliary reservoir 3 for supplying liquid to the main reservoir 2 to make up the lost of the main reservoir 2.

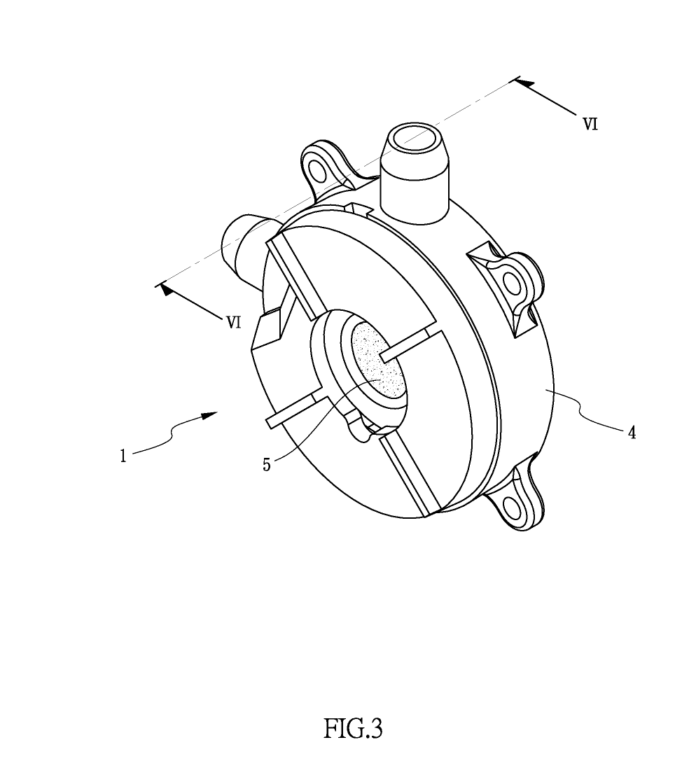

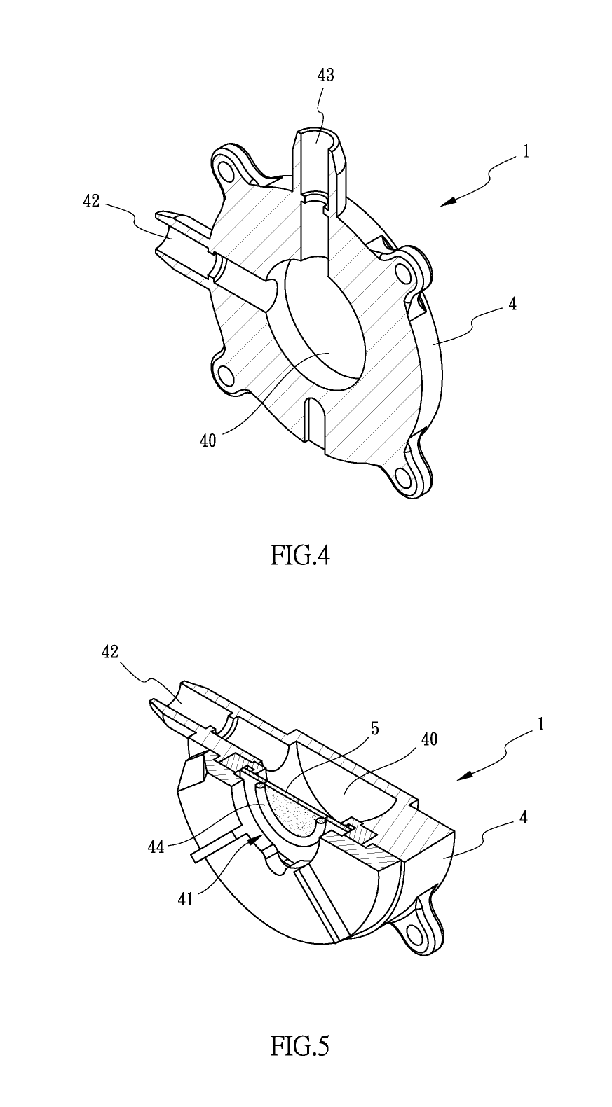

As shown in FIG. 3, the atomizer 1 includes a seat body 4 and an ultrasonic vibration plate 5 mounted in the seat body 4. As shown in FIGS. 4 and 5, the seat body 4 defines a chamber 40 and an opening 41, an inlet 42 and a gas outlet 43 each in communication with the chamber 40. The ultrasonic vibration plate 5 is disposed in between the chamber 40 and the opening 41 of the seat body 4 and is configured to transform the liquid stored in the chamber 40 into fine droplets that will exit the atomizer 1 through the opening 41 in the form of a fog. In particular, the main reservoir 2 is formed with a near-vacuum above liquid therein such that while some of the liquid flows from the main reservoir 2 to the chamber 40 of the atomizer 1, make-up liquid is automatically added to the main reservoir 2 from the auxiliary reservoir 3 to maintain the balanced pressure.

Specifically, as shown in FIG. 2, the ultrasonic spray system 100 includes a conduit 6 for connection between the main reservoir 2 and the atomizer 1, a suction tube 7 for connection between the main reservoir 2 and the auxiliary reservoir 3, and a gas pipe 8, as will be discussed in detail later. The main reservoir 2 defines in a side wall an outlet 21 and a gas inlet 23, and in a bottom wall a connection hole 22. The outlet 21 of the main reservoir 2 is connected to the inlet 42 of the seat body 4 via the conduit 6. That is, the main reservoir 2 is in fluid communication with the chamber 40 of the seat body 4 of the atomizer 1, and therefore the main reservoir 2 can supply the liquid to the atomizer 1 for atomization via the conduit 6.

The auxiliary reservoir 3 defines a connection hole 31 that is connected to the connection hole 22 of the main reservoir 2 via the suction tube 7. The suction tube 7 extends, with its top end, into the main reservoir 2, and with its bottom end, into the auxiliary reservoir 3 to have the auxiliary reservoir 3 in fluid communication with the main reservoir 2. In this mariner, when the liquid flows constantly from the main reservoir 2 to the chamber 40 of the seat body 4 for atomization, the liquid stored in the auxiliary reservoir 3 will automatically flow to the main reservoir 2 for compensation via the suction tube 7.

Referring back to FIG. 2, the main reservoir 2 defines in its top a filling orifice 24 for introducing liquid from outside of the system 100 into the main reservoir 2 and further into the auxiliary reservoir 3 via the suction tube 7. At the end, no liquid will be higher than the top end of the suction tube 7 since those above the to tope end of the suction tube 7 will fall into the suction tube 7 by gravity and finally to be stored in the auxiliary reservoir 3.

In order to form a near-vacuum above the liquid in the main reservoir 2, the suction tube 7 may be firstly blocked to allow all of the space in the main reservoir 2 be filled with liquid. Once the main reservoir 2 is completely full of the liquid, the suction tube 7 is then unblocked to permit liquid above the top end of the suction tube 7 to move downward to the auxiliary reservoir 3. Upon the auxiliary reservoir 3 is stored with enough liquid, the refilling orifice 24 in the main reservoir 2 is then closed to form the near-vacuum inside the main reservoir 2. Note that a gas hole 32 may be defined in a top of the auxiliary reservoir 3 to prevent air in the auxiliary reservoir 3 from being pushed through the suction tube 7 and into the main reservoir 2. Rather, while the liquid is introduced into the auxiliary reservoir 3, redundant gas in the auxiliary reservoir 3 may exit the auxiliary reservoir 3 through the gas hole 32.

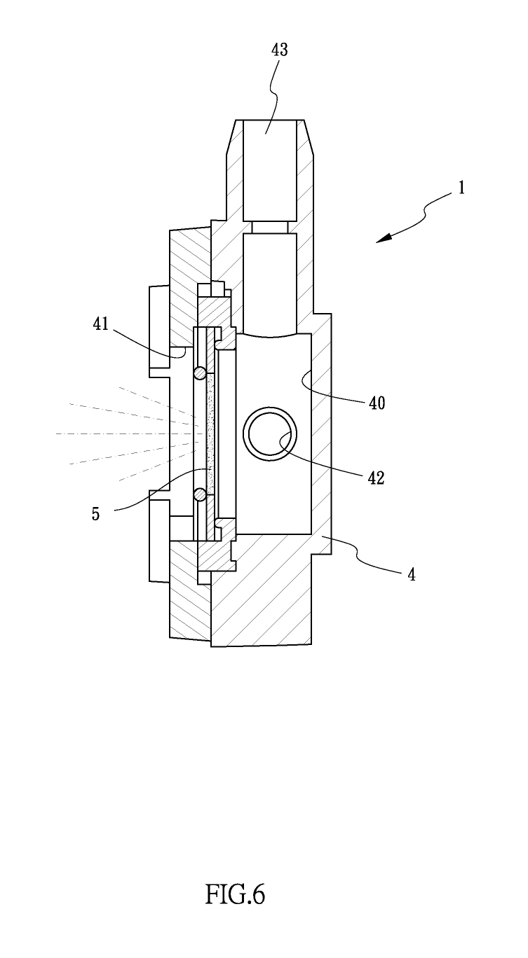

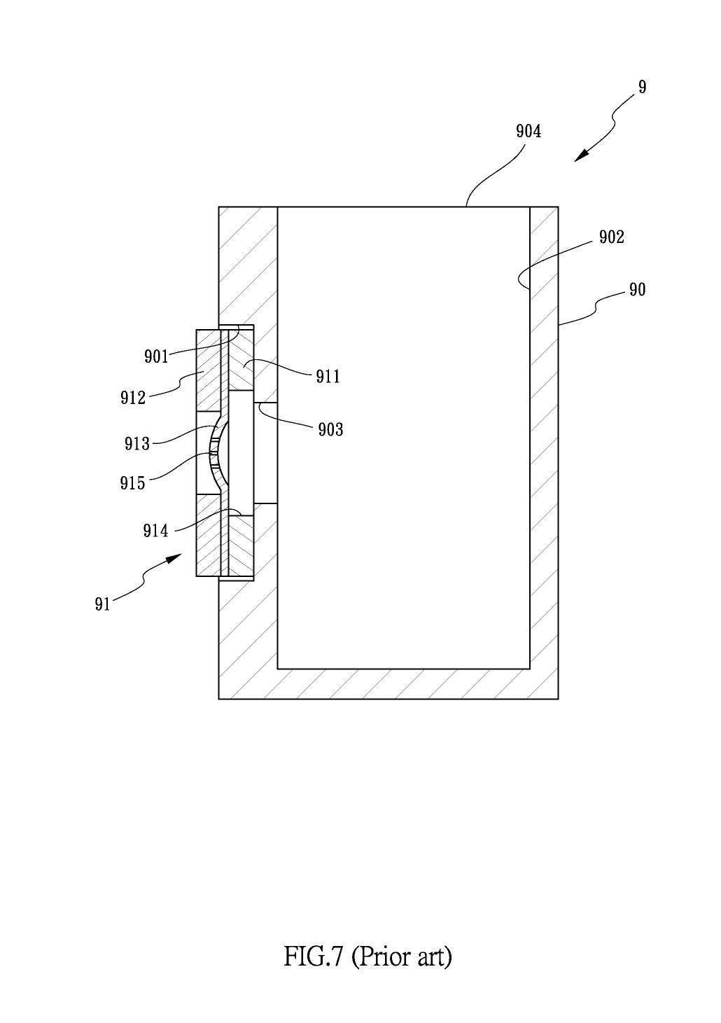

In addition, during the addition of liquid into the main reservoir 2 via the refilling orifice 24, a small amount of air may get into the main reservoir 2 accidentally and further into the chamber 40 of the seat body 4 of the atomizer 1 via the conduit 6. This may cause the atomizer 1 not to work properly. To solve this problem, as shown in FIGS. 4 and 6, the gas outlet 43 is defined in a top of the seat body 4 and above the chamber 40 to allow the air to rise and move out through the gas outlet 43 to avoid being trapped in the chamber 40. This ensures that the liquid can constantly flow from the main reservoir 2 to the atomizer 1, and the ultrasonic vibration plate 5 can function well without the interference of air. In the illustrated embodiment, the gas outlet 43 is connected to the gas inlet 23 of the main reservoir 2 via the gas pipe 8 so that the small amount of the air discharged from the gas outlet 43 of the seat body 4 may be recycled back to the main reservoir 2.

In the embodiment, the ultrasonic vibration plate 5 defines a plurality of apertures (not numbered, but shown as dotted area in FIG. 3) therein. As shown in FIG. 1 or 6, the ultrasonic vibration plate 5 is placed upright in the seat body 4 of the atomizer 1 such that the resulting fine droplets are able to be discharged through the apertures of the ultrasonic vibration plate 5 in a horizontal manner. This makes the atomizer 1 along with other parts suitable for use in an electronic cooling fan where a horizontal mist spray system is desired. Moreover, as shown in FIG. 5, a silicone ring 44 may be included in the seat body 4 and bear against one side of the ultrasonic vibration plate 5 in order to ensure that the ultrasonic vibration plate 5 is in contact with the liquid in the chamber 40 of the seat body 4 with the other side.

It should be noted that the apertures of the ultrasonic vibration plate 5 should be configured and sized according to the volume of the main reservoir 2 because the ultrasonic vibration plate 5 is subjected to the water pressure in the chamber 40 of the seat body 4, which is mainly affected by the liquid level inside the main reservoir 2, as best seen in FIG. 2. If the liquid level inside the main reservoir 2 is higher, the water pressure in the chamber 40 of the seat body 4 will also become higher and the diameter of the ultrasonic vibration plate 5 should be made smaller to sustain the higher water pressure. Otherwise, the liquid inside the chamber 40 of the seat body 4 may directly escape the seat body 4 via the apertures of the ultrasonic vibration plate 5, without being atomized. On the contrary, if the liquid level is smaller, the water pressure in the chamber 40 will also be smaller and the diameter of the ultrasonic vibration plate 5 could be bigger to provide enough flow for atomization. In this embodiment, each of the apertures of the ultrasonic vibration plate 5 has a diameter of about 60 micro meters.

For the reasons above, the main reservoir 2 is formed with a small volume for storing a small amount of liquid, and the auxiliary reservoir 3, which is disposed lower than the main reservoir 2, has a large volume for storing a large amount of liquid. This ensures that the main reservoir 2 will not generate high water pressure so that the ultrasonic vibration plate 5 can sustain the water pressure in the chamber 40 of the seat body 4. Moreover, the ultrasonic spray system 100 can still operate for a long period of time because the large amount of liquid are stored in the auxiliary reservoir 3 to be used for atomization.

It is to be understood that the disclosed embodiments are illustrative in nature and the invention is not to be limited to any one or more embodiments except as set forth in the following claims.

What is claimed is:

1. An ultrasonic spray system comprising:
an atomizer including a seat body and an ultrasonic vibration plate mounted in the seat body; the seat body defining a chamber and an opening in communication with the chamber; the ultrasonic vibration plate disposed in between the chamber and the opening of the seat body and configured to transform liquid stored in the chamber into fine droplets that exit the atomizer through the opening in the form of a fog;
a main reservoir arranged in fluid communication with the chamber of the seat body of the atomizer for supplying liquid to the atomizer;
an auxiliary reservoir arranged in fluid communication with the main reservoir;
wherein the main reservoir is formed with a near-vacuum above liquid therein such that while some of the liquid flows from the main reservoir to the chamber of the atomizer, make-up liquid is automatically added to the main reservoir from the auxiliary reservoir.

2. The ultrasonic spray system of claim 1, wherein the ultrasonic vibration plate defines a plurality of apertures therein and is placed upright in the seat body of the atomizer such that the resulting fine droplets are able to be discharged through the apertures of the ultrasonic vibration plate horizontally.

3. The ultrasonic spray system of claim 2, further comprising a silicone ring disposed in the seat body, wherein the silicone ring bears against one side of the ultrasonic vibration plate in order to ensure that the ultrasonic vibration plate is in contact with the liquid in the chamber of the seat body with the other side.

4. The ultrasonic spray system of claim 2, wherein the seat body of the atomizer further defines a gas outlet above the chamber to allow air to rise and move out through the gas outlet so as to prevent the air from being trapped in the chamber of the seat body.

5. The ultrasonic spray system of claim 4, further comprising a gas pipe through which the gas outlet of the seat body is connected to a gas inlet of the main reservoir.

6. The ultrasonic spray system of claim 4, further comprising a conduit, wherein the seat body of the atomizer further defines an inlet in communication with the chamber, and the main reservoir further defines an outlet connected to the inlet of the seat body via the conduit.

7. The ultrasonic spray system of claim 6, further comprising a suction tube, wherein the main reservoir further defines a connection hole, and the auxiliary reservoir defines a connection hole connected to the connection hole of the main reservoir via the suction tube; and wherein the suction tube extends, with its top end, into the main reservoir and, with its bottom end, into the auxiliary reservoir.

8. The ultrasonic spray system of claim 7, wherein the main reservoir further includes a filling orifice through which liquid is allowed to be added into the main reservoir and finally into the auxiliary reservoir via the suction tube.

9. The ultrasonic spray system of claim 8, wherein the auxiliary reservoir further defines a gas hole in order to prevent air in the auxiliary reservoir from being pushed into the main reservoir via the suction tube while the liquid is introduced into the auxiliary reservoir.

10. The ultrasonic spray system of claim 1, wherein the auxiliary reservoir is disposed lower than the main reservoir.
